(19) United States
(12) Patent Application Publication
(10) Pub. No.: US 2026/0051928 A1
(43) Pub. Date: Feb. 19, 2026

(54) CODEBOOK REPORT DESIGN TO SUPPORT DYNAMIC MULTI-TRP COHERENT JOINT TRANSMISSION OPERATION

(71) Applicant: APPLE INC., Cupertino, CA (US)

(72) Inventors: Haitong Sun, Cupertino, CA (US); Louay Jalloul, San Jose, CA (US); Ismael Gutierrez Gonzalez, San Jose, CA (US); David Neumann, Munich (DE); Anchit Malhotra, Santa Clara, CA (US); Dawei Zhang, Saratoga, CA (US); Wei Zeng, Santa Clara, CA (US); Ghaith N Hattab, Santa Clara, CA (US); Weidong Yang, San Diego, CA (US)

(21) Appl. No.: 19/100,957

(22) PCT Filed: Aug. 9, 2023
(86) PCT No.: PCT/US2023/071921

§ 371 Date: Feb. 4, 2025

Related U.S. Application Data
(60) Provisional application No. 63/371,003, filed on Aug. 10, 2022.

(51) Int. Cl. H04B 7/024; H04B 7/0456

(52) U.S. Cl. CPC H04B 7/024; H04B 7/0456

(57) ABSTRACT

Apparatus and methods are provided for a user equipment (UE) to perform dynamic point selection (DPS) in a wireless network. The UE receives signals from a plurality of transmission and reception points (TRPs). Different non-zero power (NZP) channel state information (CSI) reference signal (RS) resources are configured for different ones of the plurality of TRPs. The UE selects, based on the signals, one or more selected TRP of the plurality of TRPs for multiple TRP (multi-TRP) coherent joint transmission (CJT) CSI feedback. The UE configures a CSI-RS resource indicator (CRI) field in the multi-TRP CJT CSI feedback to indicate the one or more selected TRP and reports the multi-TRP CJT CSI feedback to the wireless network.

### TECHNICAL FIELD

This application relates generally to wireless communication systems, including codebook configuration.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a PMI matrix (codebook) used in certain embodiments herein.

FIG. 2 illustrates multi-TRP operation that may be used according to certain embodiments disclosed herein.

FIG. 3 illustrates a flowchart of a method for a UE to perform DPS in a wireless network according to embodiments herein.

FIG. 4 illustrates a flowchart of a method for a wireless network for DPS operation according to embodiments herein.

FIG. 5 illustrates a flowchart of a method for a UE to perform DPS in a wireless network according to embodiments herein.

FIG. 6 illustrates a flowchart of a method for a wireless network for DPS operation according to embodiments herein.

FIG. 7 illustrates an example architecture of a wireless communication system, according to embodiments disclosed herein.

FIG. 8 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Many wireless communication standards provide for the use of known signals (e.g., pilot or reference signals) for a variety of purposes, such as synchronization, measurements, equalization, control, etc. For example, in cellular wireless communications, a reference signals (RS) may be provided to deliver a reference point for downlink power. When a wireless communication device or mobile device (i.e., UE) attempts to determine downlink power (e.g., the power of the signal from a base station, such as eNB for LTE and gNB for NR), it measures the power of the reference signal and uses it to determine the downlink cell power. The reference signal also assists the receiver in demodulating the received signals. Since the reference signals include data known to both the transmitter and the receiver, the receiver may use the reference signal to determine/identify various characteristics of the communication channel. This is commonly referred to as channel estimation, which is used in many high-end wireless communications such as LTE and 5G-NR communications. Known channel properties of a communication link in wireless communications are referred to as channel state information (CSI), which provides information indicative of the combined effects of, for example, scattering, fading, and power decay with distance. The CSI makes it possible to adapt transmissions to current channel conditions, which is useful for achieving reliable communications with high data rates in multi-antenna systems.

Oftentimes multi-antenna systems use precoding for improved communications. Precoding is an extension of beamforming to support multi-stream (or multi-layer) transmissions for multi-antenna wireless communications and is used to control the differences in signal properties between the respective signals transmitted from multiple antennas by modifying the signal transmitted from each antenna according to a precoding matrix. In one sense, precoding may be considered a process of cross coupling the signals before transmission (in closed loop operation) to equalize the demodulated performance of the layers. The precoding matrix is generally selected from a codebook that defines multiple precoding matrix candidates, wherein a precoding matrix candidate is typically selected according to a desired performance level based on any of a number of different factors such as current system configuration, communication environment, and/or feedback information from the receiver (e.g., UE) receiving the transmitted signal(s).

The feedback information is used in selecting a precoding matrix candidate by defining the same codebook at both the transmitter and the receiver, and using the feedback information from the receiver as an indication of a possibly preferred precoding matrix. In such cases the feedback information includes what is referred to as a precoding matrix index (PMI), which can be based on properties of the signals received at the receiver. For example, the receiver may determine that a received signal has relatively low signal-to-noise ratio (SNR), and may accordingly transmit a PMI that would replace a current precoding matrix with a new precoding matrix to increase the signal-to-noise ratio (SNR).

In 3GPP NR systems, two types of codebook. Type I codebook and Type II codebook, have been standardized for CSI feedback in support of advanced MIMO operations. The two types of codebook are constructed from a two-dimensional (2D) discrete Fourier transform (DFT) based grid of beams, enabling CSI feedback of beam selection and phase shift keying (PSK) based co-phase combining between two polarizations. Type II codebook based CSI feedback also reports the wideband and subband amplitude information of the selected beams, allowing for more accurate CSI to be obtained. This, in turn, provides improved precoded MIMO transmissions over the network.

For Type II port selection codebook, it may be assumed that the base station will precode the CSI-RS based on channel reciprocity (i.e., DL channel estimated based on UL channel). For frequency division duplexing (FDD), exact channel reciprocity may not exist, especially when the duplexing distance is large. However, even for FDD, partial reciprocity may still exist when, for example, the angle of arrival or departure is similar between DL and UL carriers and/or the channel delay profile is similar between DL and UL carriers.

Under certain circumstances, the set of precoding matrix candidates that can be selected from the codebook may need to be limited. For example, the network may prevent the receiver from selecting some precoding matrix candidates while allowing it to select others. This is commonly referred to as codebook subset restriction (CBSR). CBSR may include the transmission of a CBSR bitmap from a transmitter (e.g., base station) to a receiver (e.g., UE). The CBSR bitmap typically includes a bit corresponding to each precoding matrix in the codebook, with the value of each bit (e.g., “0” or “1”) indicating to the receiver whether or not the receiver is restricted from considering a corresponding precoding matrix candidate as a possibly preferred precoding candidate to request from the base station. One disadvantage of CBSR is increased signaling overhead. For example, in some systems, the CBSR bitmap might contain a high number (e.g. 64) of bits per channel, requiring a transmitting device to transmit a relatively large amount of information to implement CBSR for all of its channels.

For multi-user multiple-in multiple-out (MIMO) systems, a base station may configure multiple UEs (e.g. two UEs) to report their precoding matrices, or precoding matrix candidates in mutually orthogonal directions. To reduce the CSI computation complexity for the UE, a base station may remove from consideration, based on uplink measurements, certain unlikely beams, thereby allowing the UE to not test the precoders formed by those beams that were removed from consideration. In other words, in order to reduce computation complexity, based on UL measurements the base station can restrict the UE to narrow the search space. Thus, the UE does not have to consider the entire codebook.

For 3GPP Release-15 (Rel-15) Type II port selection codebook, a beam-formed channel state information reference signal (CSI-RS) exploits downlink (DL) and uplink (UL) channel reciprocity. For example, the base station estimates the UL channel and, based on channel reciprocity, acquires the channel state information regarding the DL channel. Then, based on the DL channel information, the base station precodes different ports in CSI-RS differently for the UE to perform further CSI reporting for CSI refinement. The UE measures CSI-RS and provides feedback to the base station. For a total number X of CSI-RS ports. X/2 ports are horizontally polarized (H-pol) and X/2 ports are vertically polarized (V-pol). L CSI-RS ports are selected out of X/2 CSI-RS ports. The first CSI-RS port may be selected every d ports (e.g., d is either 1 or 2 or 3 or 4). Then, consecutive L (e.g., 1, 2, 4) ports are selected with wrap around.

3GPP Rel-16 Type II port selection codebook enhancement uses the same port selection design as 3GPP Rel-15. When subband PMI is configured, a frequency domain DFT matrix can be used to compress the linear combination coefficients.

For Type II port selection codebook, it may be assumed that the base station will precode the CSI-RS based on channel reciprocity (i.e., DL channel estimated based on UL channel). For frequency division duplexing (FDD), exact channel reciprocity may not exist, especially when the duplexing distance is large. However, even for FDD, partial reciprocity may still exist when, for example, the angle of arrival or departure is similar between DL and UL carriers and/or the channel delay profile is similar between DL and UL carriers.

Embodiment herein provide support for a CSI report for CJT for multi-TRP CSI for up to multiple TRPs (e.g., four TRPs). In order to support CSI for CJT for multi-TRP, a network may provide the UE with a channel measurement resource (CMR) configuration that identifies how a CMR should be associated with each TRP. The network node may configure a resource set and within that set configure multiple resources and within that resources multiple ports.

In NR, CSI may be configured in CSI-ReportConfig. A CMR resource is configured in the CSI-ResourceConfig. For periodic and semi-persistent CSI, the carrier field in CSI-ReportConfig indicates the serving cell that contains the CMR. Further, the resources ForChannelMeasurement indicates which CMR resource set in CSI-ResourceConfig contains the CMR. For aperiodic CSI the CMR is additionally indicated in CSI-AssociatedReportConfigInfo.

CSI reports for the multi-TRP may be done at any level of the CMR hierarchal structure (e.g., multiple resource sets, resources within a resource set, or ports within the resources). For example, the CMR configuration may use CSI-RS port splitting, CSI-RS resource set splitting, and/or multiple CSI-RS resource sets. For CSI-RS port splitting, in one embodiment, each resource may include multiple ports (e.g., up to thirty-two ports). The network may assign different ports to different TRPs. The network may indicate to the UE that a first channel measurement should belongs to a first TRP and a second channel measurement should belong to a second TRP. In some embodiments, the network may use CSI-RS resource set splitting by associating all the ports in a resource with on TRP and all the ports in other resources with different TRPs. In some embodiments, the network may also use multiple CSI-RS resource sets and associate different TRPs with each of the CSI-RS resource sets.

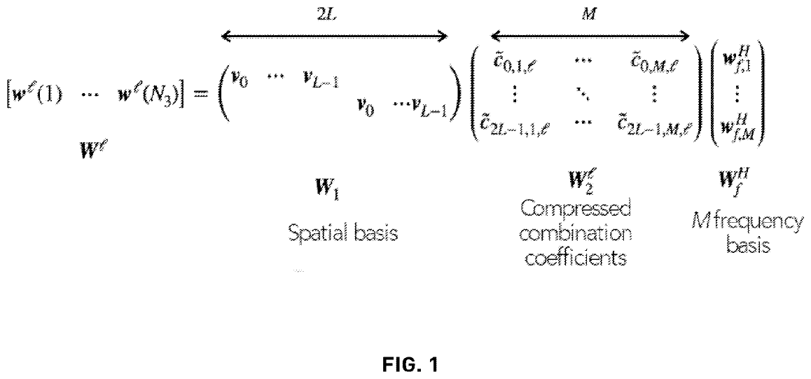

FIG. 1 illustrates a PMI matrix (codebook) used in certain embodiments herein. In the illustrated example, a Type II port selection codebook structure is given by

$${W}^{ℓ} = {W}_{1} ⋆ {W}_{2}^{ℓ} ⋆ {W}_{f}^{H}$$

also notated for simplicity herein as W=W₁*W₂*W_{f} or W=w1W2Wf), where W is the PMI matrix (also referred to herein simply as codebook), W₁ is a spatial basis selection matrix (also referred to herein as a port selection matrix W₁), W₂ provides compressed combination coefficients, W_{f} is a frequency basis selection matrix, [symbol] is a layer index, N₃ is the number of PMI subbands in frequency (i.e., the length or number of entries in each frequency base), L is the number of selected spatial basis (i.e., number of selected ports), M is the number of selected frequency basis, and H denotes a Hermitian matrix or conjugate transpose operation. For simplicity, “W_{f}” or “Wf” assumes that the Hermitian operation has already been performed. These and other parameters of

$${W}^{ℓ} = {W}_{1} ⋆ {W}_{2}^{ℓ} ⋆ {W}_{f}^{H}$$

are shown in other figures and/or described in detail below.

In certain systems, for port selection codebook enhancements utilizing DL/UL reciprocity of angle and/or delay, support is provided for codebook structure W=W₁*W₂*W where the port selection matrix W₁ is a free selection matrix, with the identity matrix as a special configuration. The frequency basis selection matrix Wf is a DFT based compression matrix in which N₃=N_{CQISubband}*R and Mv>=1, where R is a size of the channel quality indicator (CQI) subband divided by the size of the PMI subband, and Mv is the number of selected frequency basis. N₃ is the number of PMI subbands for frequency basis selection. At least one value of Mv>1 may be supported. In certain such systems, value(s) of My may be decided (e.g., Mv=2). In other embodiments, support of Mv>1 is a UE optional feature, taking into account UE complexity related to codebook parameters. However, candidate value(s) of R, mechanisms for configuring/indicating to the UE and/or mechanisms for selecting/reporting by UE for W_{f} have yet to be determined. In addition, or in other systems, We can be turned off by the base station. When turned off, W_{f} may be an all-one vector.

In Rel-15, Type II and Type II port selection codebook is specified based on W₁*W₂. In Rel-16, enhanced Type II and Type II port selection codebook is specified based on W₁*W₂*W_{f}.

In Rel-17, further enhanced Type II port selection codebook is specified. For example, CSI feedback in Rel-17 is further enhanced for non-coherent joint transmission (NCJT) for multiple transmission and reception point (TRP) operation (referred to as multi-TRP or mTRP). In certain wireless networks, NCJTs may be used to provide multiple-input multiple-output (MIMO), multiple-user (MU) MIMO, and/or coordinated multi-point (CoMP) communications. The NCJTs may be from multi-TRP, multiple panels (multi-panels) of a TRP, or a combination thereof. Coherent joint transmission (CJT) uses synchronization among TRPs. However, for distributed TRPs, the precoders may not be jointly designed and such that the TRPs are not synchronized. Instead, each TRP derives the precoder independently without knowledge of the precoders used by the other TRPs. Thus, the joint transmission is non-coherent. In Rel-17, CSI feedback for NCJT for multi-TRPs is based on Type I MIMO codebook, which may supports single downlink control information (DCI) multi-TRP NCJT scheme 1a (i.e., spatial domain multiplexing (SDM)).

In certain communication systems (e.g., Rel-18 NR), it may be desirable to provide CSI enhancement to support CJT for multi-TRP. CJT assumes that multiple TRPs can jointly precode the transmission in a coherent way. Certain such systems may, for example, target frequency range 1 (FR1) and up to four TRPs, assuming an ideal backhaul and synchronization as well as the same number of antenna ports across TRPs, as follows: Rel-16/17 Type II codebook refinement for CJT mTRP targeting FDD and its associated CSI reporting, taking into account throughput-overhead tradeoff. However, embodiments disclosed herein are not so limited (fewer than four or more than four TRPs may be used).

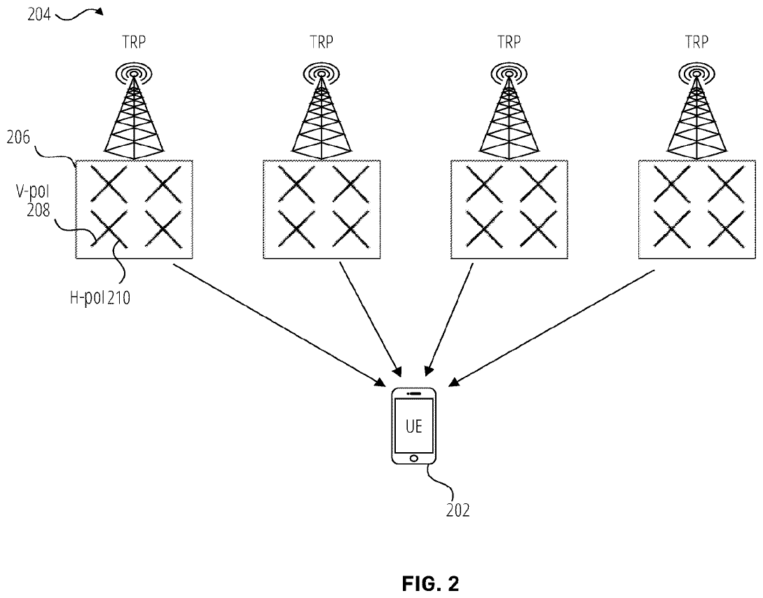

For example, FIG. 2 illustrates multi-TRP operation that may be used according to certain embodiments disclosed herein. A UE 202 receives signals from four TRPs 204. Each TRP includes an antenna panel 206 that has eight ports (i.e., antenna elements), wherein four of the ports are V-pol and four of the ports are H-pol. For example, a cross-polarized antenna may include a V-pol port 208 and an H-pol port 210. Thus, the four TRPs 204 use a combined total of 32 ports. In certain embodiments, for multi-TRP CJT CSI reporting, the UE 202 may use a codebook structure is given by

$$W = [ \begin{matrix}\begin{matrix}{c}^{1} \cdot {W}^{1} \\ …\end{matrix} \\ {c}^{T} \cdot {W}^{T}\end{matrix} ]$$

$$or$$

$$W = {\sum }_{{t - 1}_{}}^{T} {c}^{t} \cdot {W}^{t} ,$$

in which t is a TRP index corresponding to a particular TRP, T is a total number of TRPs, W¹, . . . , W^{t} are Type II CSI codebooks reported for TRPs corresponding to index

$$( i . e . , {W}^{t} = {W}_{1}^{t} \cdot {W}_{2}^{t} \cdot {W}_{{f}^{}}^{t} ) ,$$

and c¹, . . . , c^{t} are linear combination coefficients applied to each codebook for different TRPs. As used herein, the linear combination coefficients c¹, . . . , c^{t} may also be referred to as co-phasing coefficients when the amplitude=1.

Because the antenna panels of the respective TRPs 204 are not co-located, beams arriving at the UE 202 from the different TRPs 204 may not have the same quality, and one or more of the beams may be blocked. Thus, certain embodiments disclosed herein allow the UE to select the TRP(s) that participate in the CJT operation. For example, embodiments providing CSI report design to support dynamic multi-TRP CJT operation include one or more of: support of dynamic point selection (DPS) based a on CSI reference signal (CSI-RS) resource indicator (CRI): support of DPS based on a co-phasing coefficient: support of DPS based reporting different PMI matrix W (including a different spatial basis selection matrix

$${W}_{1}^{t} ,$$

a different frequency bases selection matrix

$${W}_{f}^{t} ,$$

and/or a different combination efficient matrix

$${W}_{2}^{t} ) ;$$

and/or a CSI configuration.

### DPS Based on CRI

In certain embodiments, for Multi-TRP CJT CSI codebook, if different non-zero power (NZP) CSI-RS resources (NZP-CSI-RS-Resource) are configured for different TRPs, a CRI field may be used to indicate which TRP is selected in the CJT CSI feedback. The CRI may be reported in CSI part 1 to avoid CSI size ambiguity. For a TRP that the corresponding CRI is not reported, the corresponding combination coefficients c and matrices

$${W}_{1}^{t} , {W}_{2}^{t} , {W}_{f}^{t}$$

are omitted from the CSI codebook report. The total bitwidth of CRI is given by

$$⌈ {log}_{2} ( {\prod }_{i = 1}^{T} ( {N}_{i} + 1 ) - 1 ) ⌉ ,$$

where T is the total number of configured TRP for the CJT operation Nᵢ is the number of CSI-RS resources configured as CMR for TRP i, and Π is the product operation.

In certain embodiments, for multi-TRP CJT CSI codebook, when a CRI field is used to indicate which TRP(s) are selected in the CJT CSI feedback, the CRI field may include two parts. CRI part 1 indicates how many TRPs are selected. CRI part 2 indicates which TRPs are selected. In one such embodiment, both CRI part 1 and CRI part 2 are included in CSI part 1. In another embodiment, CRI part 1 is included in CSI part 1 and CRI part 2 is included in CSI part 2, group 0.

In certain embodiments of multi-TRP CJT CSI codebook, for DPS reporting, the UE may select no TRP. For example, if a CRI field is used for DPS, as discussed above, then the total bitwidth of CRI is given by

$$⌈ {log}_{2} ( {\prod }_{i = 1}^{T} ( {N}_{i} + 1 ) ) ⌉ ,$$

wherein one codepoint is mapped to selecting no TRP. In certain such embodiments, when the UE reports that UE selects no TRP for DPS, the network may interpret the indication as the UE preferring the same CSI as that reported by the UE in the last report.

In certain embodiments, for multi-TRP CJT CSI codebook, when a CRI field is used to indicate which TRP is selected in the CJT CSI feedback, the CRI may be reported with different (i.e., larger) periodicity compared to the other report quantities including PMI (W), linear combination coefficients c, etc.

In certain embodiments, ports to TRP mapping for each of the one or more resources (e.g., NZP-CSI-RS-Resource) may be hard coded and/or configured by the network. Ports to TRP mapping indicates which ports belong to the same TRP. In some embodiments, the ports to TRP mapping for the resources is hard coded in the specification based on a limited number of deployment choices. In some embodiments, the ports to TRP mapping for the resources is configured by the network node by radio resource control (RRC) signaling or Medium Access Control (MAC) control element (CE). In some embodiments, the ports to TRP mapping is configured by a combination of hard coded deployment choices and configuration by the network. For example, several deployment choices may be hard coded in the specification and a network node may use RRC signaling or MAC CE to indicate to the UE which deployment choice to use.

### DPS Based on Co-Phasing Coefficient

In certain embodiments, for multi-TRP CJT CSI codebook, for DPS reporting, the UE can report which TRP(s) are selected as linear combination coefficients. This may be useful, for example, when there is no CRI report. For each c^{t}, both phase and amplitude reporting may be allowed. For amplitude, one of the quantized codepoints may map to 0. The co-phasing coefficients c^{t} may be reported either in CSI report part 1 or CSI report part 2 group 0, to avoid CSI size ambiguity. For a TRP that has c′ reported as 0, the corresponding matrices

$${W}_{1}^{t} , {W}_{2}^{t} , {W}_{f}^{t}$$

may be omitted.

In certain embodiments, for multi-TRP CJT CSI codebook, if linear combination coefficients (i.e., c^{t}) are used for DPS reporting, when differential encoding between different TRPs is used to compress c^{t} quantization bits, the UE is allowed to indicate to the network in the CSI report, which TRP is the strongest. In one such embodiment, the strongest TRP may be selected, wherein corresponding c^{t} is phase quantized to 0 and amplitude quantize to 1. In addition or in other embodiments, the UE also reports whether the strongest TRP is selected, wherein if the UE reports that the strongest TRP is not selected, the network assumes that the UE selected no TRP.

In another embodiment, for multi-TRP CJT CSI codebook, if linear combination coefficients (i.e., c^{t}) are used for DPS reporting, when differential encoding between different TRPs is used to compress c^{t} quantization bits, the UE reports CSI assuming that the first TRP may be the strongest and/or a reference.

### DPS Based on W Report

In certain embodiments of multi-TRP CJT CSI codebook, for DPS reporting, the UE may report which TRP is selected as the spatial basis selection matrix

$${W}_{1}^{t}$$

reported for each TRP. This may be useful, for example, when there is no CRI and linear combination coefficient c^{t} report. Certain embodiments use a special codepoint the spatial basis selection matrix

$${W}_{1}^{t}$$

allow UE to indicate the UE selects no spatial basis for the corresponding TRP.

When the UE reports one or multiple

$${W}_{1}^{t}$$

to include zero spatial bases, the matrices

$${W}_{2}^{t} , {W}_{f}^{t}$$

may be jointly reported or dependently reported. If the matrices

$${W}_{2}^{t} or {W}_{f}^{t}$$

are reported by the UE in CSI for the TRPs, the corresponding joint

$${W}_{2}^{t} , {W}_{f}^{t}$$

matrix size is reduced to exclude the TRP(s) with zero selected spatial basis. If independent matrices

$${W}_{2}^{t} and {W}_{f}^{t}$$

are separately reported by the UE in CSI for the corresponding TRPs, the corresponding independent matrices

$${W}_{2}^{t} and {W}_{f}^{t}$$

are omitted for TRP(s) with zero spatial basis.

In certain embodiments of multi-TRP CJT CSI codebook, for DPS reporting, when the spatial basis selection matrix

$${W}_{1}^{t}$$

reported for each TRP is used for DPS, the UE is allowed to report that zero spatial basis is selected for the TRPs. In another embodiment, when the spatial basis selection matrix

$${W}_{1}^{t}$$

reported for each TRP is used for DPS, the UE reports that a non-zero number of spatial basis is selected for at least one TRP.

In certain embodiments of multi-TRP CJT CSI codebook, for DPS reporting, the UE may report which TRP is selected as part of the combination coefficient matrix

$${W}_{2}^{t}$$

reported for each TRP. This may be useful, for example, when there is no CRI and co-phasing coefficient c^{t} report and the combination coefficient matrix

$${W}_{2}^{t}$$

is jointly reported for all the TRPs. For the coefficients in the combination coefficient matrix

$${W}_{2}^{t}$$

corresponding to a particular TRP, the UE can report that the coefficients are quantized with amplitude zero. If differential quantization is adopted, for example, and each TRP has its own reference coefficient, for the reference coefficient location reporting for the TRP, the UE may report the location as not applicable (“N/A”). As another example, if differential quantization is adopted and each TRP has its own reference coefficient, the UE may report the amplitude quantization of the reference coefficient for the TRP as 0.

### CSI Configuration

In certain embodiments, when the network configures the UE to report multi-TRP CJT CSI, in the same CSI, the UE may be configured to simultaneously report one or multiple of the following: the best four TRP CJT operation; the best three TRP operation, including which three TRP of the four TRPs: the best two TRP operation, including which two TRP from the four TRPs; and/or the best one TRP operation, including which TRP from the four TRPs.

In certain embodiments, when the network configures the UE to report multi-TRP CJT CSI, the network may configure UE to report the CSI for selected TRP(s). For example, for single TRP operation, the network may configure the UE to report the CSI for each TRP. Thus, the UE reports the CSI (PMI. CRI. Rank indicator (RI). CQI, etc.) for each TRP in the TRPs assuming single TRP operation.

In certain embodiments, when the network configures UE to report multi-TRP CJT CSI, to reduce the hypothesis that the UE needs to test, the network may configure a list of possible TRP combinations. For example, the network may configure the following eight possible TRP combinations: {TRP1, TRP2, TRP3, TRP4}; {TRP1, TRP2, TRP3}; {TRP1, TRP2}; {TRP3, TRP4}; {TRP1}; {TRP2}; {TRP3}; and {TRP4}. The UE can select one or multiple TRP combinations from the configured list of possible TRP combinations.

In another embodiment, when the network configures UE to report multi-TRP CJT CSI, to reduce the hypothesis that the UE needs to test, the network may configure one or multiple lists, wherein each list includes the TRP that can be selected. For example, the can configure the following two combinations: {TRP1, TRP2, TRP3, TRP4}; and {TRP2, TRP3, TRP4}. For CJT operation, the UE may select one or more multiple TRPs from either the first list or the second list.

In certain embodiments, when the network configures the UE to report multi-TRP CJT CSI, the following are possible restrictions: for each TRP, the network may configure one NZP-CSI-RS-Resource as a channel measurement resource (CMR); and/or across all the TRPs, the maximum total number of NZP-CSI-RS ports is 32.

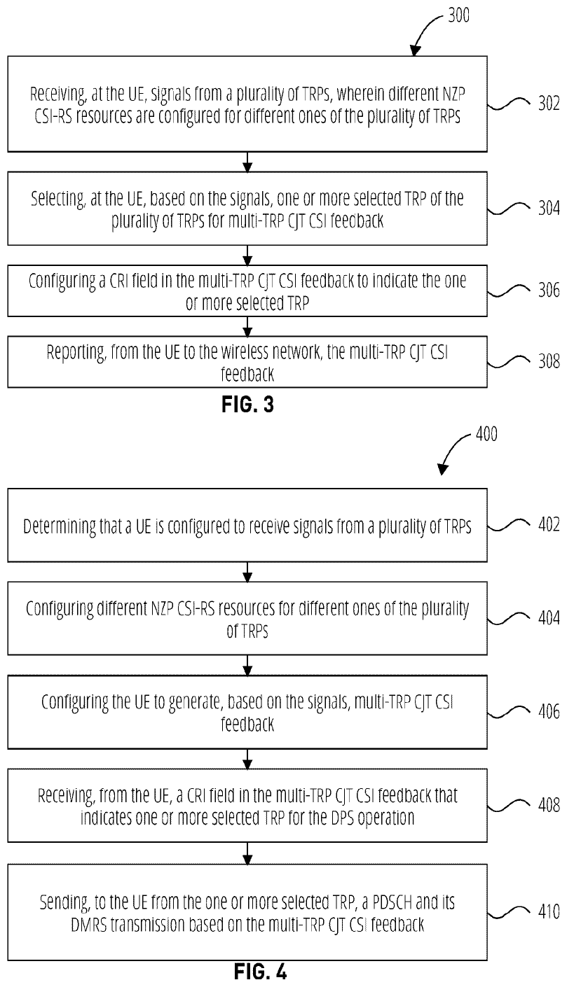

FIG. 3 illustrates a flowchart of a method 300 for a UE to perform DPS in a wireless network according to embodiments herein. The illustrated method 300 includes receiving 302, at the UE, signals from a plurality of TRPs, wherein different NZP CSI-RS resources are configured for different ones of the plurality of TRPs. The method 300 further includes selecting 304, at the UE, based on the signals, one or more selected TRP of the plurality of TRPs for multi-TRP CJT CSI feedback. The method 300 further includes configuring 306 a CRI field in the multi-TRP CJT CSI feedback to indicate the one or more selected TRP. The method 300 further includes reporting 308, from the UE to the wireless network, the multi-TRP CJT CSI feedback.

In some embodiments of the method 300, the multi-TRP CJT CSI feedback comprises UCI in a CSI part 1 and a CSI part 2, and the CRI is reported in the CSI part 1.

In some embodiments of the method 300, the multi-TRP CJT CSI feedback uses a codebook W given by

$$W = [ \begin{matrix}{c}^{1} \cdot {W}^{1} \\ … \\ {c}^{T} \cdot {W}^{T}\end{matrix} ] ,$$

for linear combination coefficients c¹, . . . , c^{t}, codebooks w¹, . . . , w^{t}, a TRP index t, and a total number T of the plurality of TRPs. and

$${W}^{t} = {W}_{1}^{t} \cdot {W}_{2}^{t} \cdot {W}_{f}^{t}$$

for a spatial bases selection matrix

$${W}_{1}^{t} ,$$

a combination coefficient matrix

$${W}_{2}^{t} ,$$

and a frequency bases selection matrix

$${W}_{f}^{t} .$$

Some such embodiments, further comprise: reporting, in the multi-TRP CJT CSI feedback, the linear combination coefficients c¹, . . . , c^{t}, the spatial basis selection matrix

$${W}_{1}^{t} ,$$

the combination coefficient matrix

$${W}_{2}^{t} ,$$

and the frequency bases selection matrix

$${W}_{f}^{t}$$

corresponding to the one or more selected TRP of the plurality of TRPs, and omitting, from the multi-TRP CJT CSI feedback, the linear combination coefficients c¹, . . . , c^{t}, the spatial basis selection matrix

$${W}_{1}^{t} ,$$

the combination coefficient matrix

$${W}_{2}^{t} ,$$

and the frequency bases selection matrix

$${W}_{f}^{t}$$

corresponding to non-selected TRP of the plurality of TRPs. In addition, or in other embodiments, a bitwidth of the CRI field comprises

$$⌈ {log}_{2} ( {\prod }_{i = 1}^{T} ( {N}_{i} + 1 ) - 1 ) ⌉ ,$$

where Nₜ is a number of CSI-RS resources configured as a CMR for a TRP i, and Π is a product operation.

In some embodiments of the method 300, the UE is configured by the wireless network to use a same CSI to report the multi-TRP CJT CSI feedback, and the UE is configured by the wireless network to simultaneously report a predetermined number of best TRP CJT operation. In some such embodiments, the predetermined number is in a range between one and four.

In some embodiments of the method 300, for each TRP of the plurality of TRPs, the UE is configured by the wireless network with one of the NZP CSI-RS resources as a channel measurement resource.

Embodiments contemplated herein include an apparatus comprising means to perform one or more elements of the method 300. This apparatus may be, for example, an apparatus of a UE (such as a wireless device 802 that is a UE, as described herein).

Embodiments contemplated herein include one or more non-transitory computer-readable media comprising instructions to cause an electronic device, upon execution of the instructions by one or more processors of the electronic device, to perform one or more elements of the method 300. This non-transitory computer-readable media may be, for example, a memory of a UE (such as a memory 806 of a wireless device 802 that is a UE, as described herein).

Embodiments contemplated herein include an apparatus comprising logic, modules, or circuitry to perform one or more elements of the method 300. This apparatus may be, for example, an apparatus of a UE (such as a wireless device 802 that is a UE, as described herein).

Embodiments contemplated herein include an apparatus comprising: one or more processors and one or more computer-readable media comprising instructions that, when executed by the one or more processors, cause the one or more processors to perform one or more elements of the method 300. This apparatus may be, for example, an apparatus of a UE (such as a wireless device 802 that is a UE, as described herein).

Embodiments contemplated herein include a signal as described in or related to one or more elements of the method 300.

Embodiments contemplated herein include a computer program or computer program product comprising instructions, wherein execution of the program by a processor is to cause the processor to carry out one or more elements of the method 300. The processor may be a processor of a UE (such as a processor(s) 804 of a wireless device 802 that is a UE, as described herein). These instructions may be, for example, located in the processor and/or on a memory of the UE (such as a memory 806 of a wireless device 802 that is a UE, as described herein).

FIG. 4 illustrates a flowchart of a method 400 for a wireless network for DPS operation according to embodiments herein. The illustrated method 400 includes determining 402 that a UE is configured to receive signals from a plurality of TRPs. The method 400 further includes configuring 404 different NZP CSI-RS resources for different ones of the plurality of TRPs. The method 400 further includes configuring 406 the UE to generate, based on the signals, multi-TRP CJT CSI feedback. The method 400 further includes receiving 408, from the UE, a CRI field in the multi-TRP CJT CSI feedback that indicates one or more selected TRP for the DPS operation. The method 400 further includes sending 410, to the UE from the one or more selected TRP, a physical downlink shared channel (PDSCH) and its DMRS transmission based on the multi-TRP CJT CSI feedback.

In some embodiments of the method 400, the multi-TRP CJT CSI feedback comprises UCI in a CSI part 1 and a CSI part 2, and the CRI is reported in the CSI part 1.

In some embodiments of the method 400, the multi-TRP CJT CSI feedback uses a codebook W given by

$$W = [ \begin{matrix}\begin{matrix}{c}^{1} \cdot {W}^{1} \\ ⋯\end{matrix} \\ {c}^{T} \cdot {W}^{T}\end{matrix} ] ,$$

for linear combination coefficients c¹, . . . , c^{t}, codebooks w¹, . . . , w^{t}, a TRP index t, and a total number T of the plurality of TRPs, and

$${W}^{t} = {W}_{1}^{t} \cdot {W}_{2}^{t} \cdot {W}_{f}^{t}$$

for a spatial basis selection matrix a

$${W}_{1}^{t} ,$$

combination coefficient matrix

$${W}_{2}^{t} ,$$

and a frequency basis selection matrix

$${W}_{f}^{t} .$$

Some such embodiments further comprise: decoding, from the multi-TRP CJT CSI feedback, the linear combination coefficients c¹, . . . , c^{t}, the spatial basis selection matric

$${W}_{1}^{t} ,$$

the combination coefficient matrix

$${W}_{2}^{t} ,$$

and the frequency bases selection matrix

$${W}_{f}^{t}$$

corresponding to the one or more selected TRP of the plurality of TRPs, wherein the linear combination coefficients c¹, . . . , c^{t}, the spatial basis selection matrix

$${W}_{1}^{t} ,$$

the combination coefficient matrix

$${W}_{2}^{t} ,$$

and the frequency basis selection matrix

$${W}_{f}^{t}$$

corresponding to the non-selected TRP of the plurality of TRPs are omitted, from the multi-TRP CJT CSI feedback. In addition, or in other embodiments, a bitwidth of the CRI field comprises

$$⌈ {log}_{2} ( {\prod }_{i = 1}^{T} ( {N}_{i} + 1 ) - 1 ) ⌉ ,$$

where Nₜ is a number of CSI-RS resources configured as a CMR for a TRP i, and Π is a product operation.

In some embodiments, the method 400 further comprises configuring the UE, by the wireless network, to: use a same CSI to report the multi-TRP CJT CSI feedback; and simultaneously report a predetermined number of best TRP CJT operation. In some such embodiments, the predetermined number is in a range between one and four.

In some embodiments, the method 400 further comprises, for each TRP of the plurality of TRPs, configuring the UE, by the wireless network, with one of the NZP CSI-RS resources as a channel measurement resource.

Embodiments contemplated herein include an apparatus comprising means to perform one or more elements of the method 400. This apparatus may be, for example, an apparatus of a base station (such as a network device 818 that is a base station, as described herein).

Embodiments contemplated herein include one or more non-transitory computer-readable media comprising instructions to cause an electronic device, upon execution of the instructions by one or more processors of the electronic device, to perform one or more elements of the method 400. This non-transitory computer-readable media may be, for example, a memory of a base station (such as a memory 822 of a network device 818 that is a base station, as described herein).

Embodiments contemplated herein include an apparatus comprising logic, modules, or circuitry to perform one or more elements of the method 400. This apparatus may be, for example, an apparatus of a base station (such as a network device 818 that is a base station, as described herein).

Embodiments contemplated herein include an apparatus comprising: one or more processors and one or more computer-readable media comprising instructions that, when executed by the one or more processors, cause the one or more processors to perform one or more elements of the method 400. This apparatus may be, for example, an apparatus of a base station (such as a network device 818 that is a base station, as described herein).

Embodiments contemplated herein include a signal as described in or related to one or more elements of the method 400.

Embodiments contemplated herein include a computer program or computer program product comprising instructions, wherein execution of the program by a processing element is to cause the processing element to carry out one or more elements of the method 400. The processor may be a processor of a base station (such as a processor(s) 820 of a network device 818 that is a base station, as described herein). These instructions may be, for example, located in the processor and/or on a memory of the base station (such as a memory 822 of a network device 818 that is a base station, as described herein).

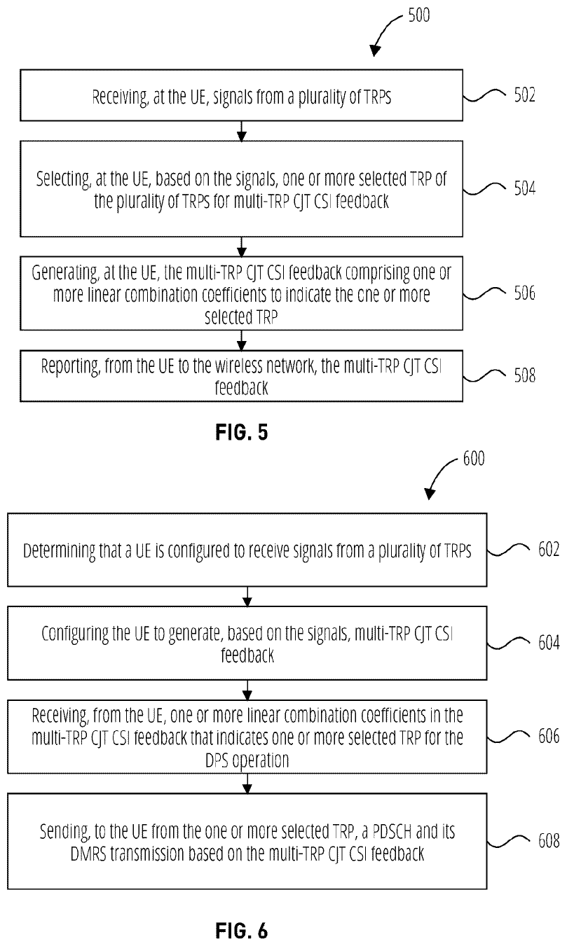

FIG. 5 illustrates a flowchart of a method 500 for a UE to perform DPS in a wireless network according to embodiments herein. The illustrated method 500 includes receiving 502, at the UE, signals from a plurality of TRPs. The method 500 further includes selecting 504, at the UE, based on the signals, one or more selected TRP of the plurality of TRPs for multi-TRP CJT CSI feedback. The method 500 further includes generating 506, at the UE, the multi-TRP CJT CSI feedback comprising one or more linear combination coefficients to indicate the one or more selected TRP. The method 500 further includes reporting 508, from the UE to the wireless network, the multi-TRP CJT CSI feedback.

In some embodiments of the method 500, differential encoding is used to between different ones of the plurality of TRPs to compress quantization bits for the linear combination coefficients, and the method further comprises indicating, from the UE to the wireless network in the CSI feedback, a strongest TRP of the one or more selected TRPs.

In some embodiments of the method 500, the UE is configured by the wireless network to use a same CSI to report the multi-TRP CJT CSI feedback, and wherein the UE is configured by the wireless network to simultaneously report a predetermined number of best TRP CJT operation. In some such embodiments, the predetermined number is in a range between one and four.

In some embodiments of the method 500, for each TRP of the plurality of TRPs, the UE is configured by the wireless network with one NZP CSI-RS resource as a channel measurement resource.

Embodiments contemplated herein include an apparatus comprising means to perform one or more elements of the method 500. This apparatus may be, for example, an apparatus of a UE (such as a wireless device 802 that is a UE, as described herein).

Embodiments contemplated herein include one or more non-transitory computer-readable media comprising instructions to cause an electronic device, upon execution of the instructions by one or more processors of the electronic device, to perform one or more elements of the method 500. This non-transitory computer-readable media may be, for example, a memory of a UE (such as a memory 806 of a wireless device 802 that is a UE, as described herein).

Embodiments contemplated herein include an apparatus comprising logic, modules, or circuitry to perform one or more elements of the method 500. This apparatus may be, for example, an apparatus of a UE (such as a wireless device 802 that is a UE, as described herein).

Embodiments contemplated herein include an apparatus comprising: one or more processors and one or more computer-readable media comprising instructions that, when executed by the one or more processors, cause the one or more processors to perform one or more elements of the method 500. This apparatus may be, for example, an apparatus of a UE (such as a wireless device 802 that is a UE, as described herein).

Embodiments contemplated herein include a signal as described in or related to one or more elements of the method 500.

Embodiments contemplated herein include a computer program or computer program product comprising instructions, wherein execution of the program by a processor is to cause the processor to carry out one or more elements of the method 500. The processor may be a processor of a UE (such as a processor(s) 804 of a wireless device 802 that is a UE, as described herein). These instructions may be, for example, located in the processor and/or on a memory of the UE (such as a memory 806 of a wireless device 802 that is a UE, as described herein).

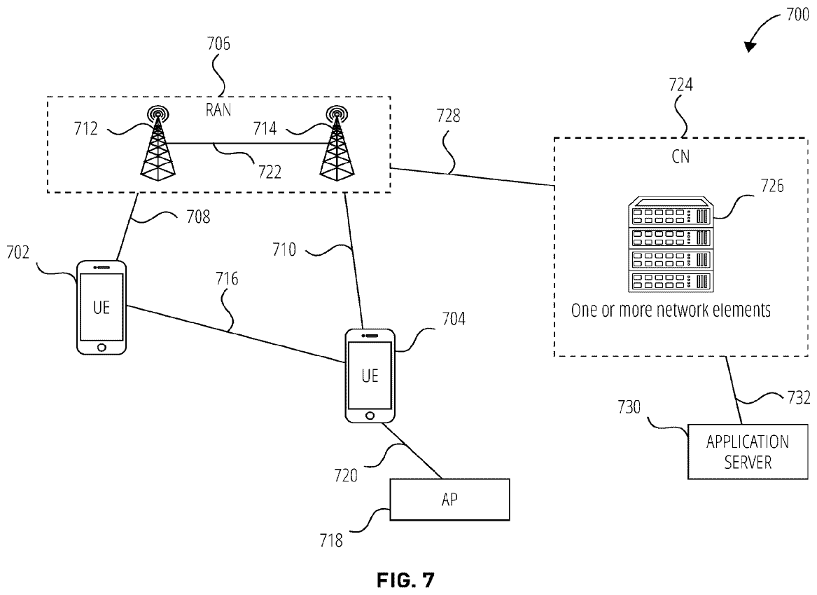

FIG. 6 illustrates a flowchart of a method 600 for a wireless network for DPS operation according to embodiments herein. The illustrated method 600 includes determining 602 that a UE is configured to receive signals from a plurality of TRPs. The method 600 further includes configuring 604 the UE to generate, based on the signals, multi-TRP CJT CSI feedback. The method 600 further includes receiving 606, from the UE, one or more linear combination coefficients in the multi-TRP CJT CSI feedback that indicates one or more selected TRP for the DPS operation. The method 600 further includes sending 608, to the UE from the one or more selected TRP, a PDSCH and its DMRS transmission based on the multi-TRP CJT CSI feedback.

In some embodiments of the method 600, differential encoding is used between different ones of the plurality of TRPs to compress quantization bits for the linear combination coefficients, and the method further comprises receiving, from the UE, in the CSI feedback, an indication of a strongest TRP of the one or more selected TRPs.

In some embodiments, the method 600 further comprises configuring the UE, by the wireless network, to use a same CSI to report the multi-TRP CJT CSI feedback, and simultaneously reporting a predetermined number of best TRP CJT operation. In some such embodiments, the predetermined number is in a range between one and four.

In some embodiments, the method 600 further comprises, for each TRP of the plurality of TRPs, configuring the UE, by the wireless network, with one NZP CSI-RS resource as a channel measurement resource.

Embodiments contemplated herein include an apparatus comprising means to perform one or more elements of the method 600. This apparatus may be, for example, an apparatus of a base station (such as a network device 818 that is a base station, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a base station (such as a memory 822 of a network device 818 that is a base station, as described herein).

Embodiments contemplated herein include an apparatus comprising logic, modules, or circuitry to perform one or more elements of the method 600. This apparatus may be, for example, an apparatus of a base station (such as a network device 818 that is a base station, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a base station (such as a network device 818 that is a base station, as described herein).

Embodiments contemplated herein include a signal as described in or related to one or more elements of the method 600.

Embodiments contemplated herein include a computer program or computer program product comprising instructions, wherein execution of the program by a processing element is to cause the processing element to carry out one or more elements of the method 600. The processor may be a processor of a base station (such as a processor(s) 820 of a network device 818 that is a base station, as described herein). These instructions may be, for example, located in the processor and/or on a memory of the base station (such as a memory 822 of a network device 818 that is a base station, as described herein).

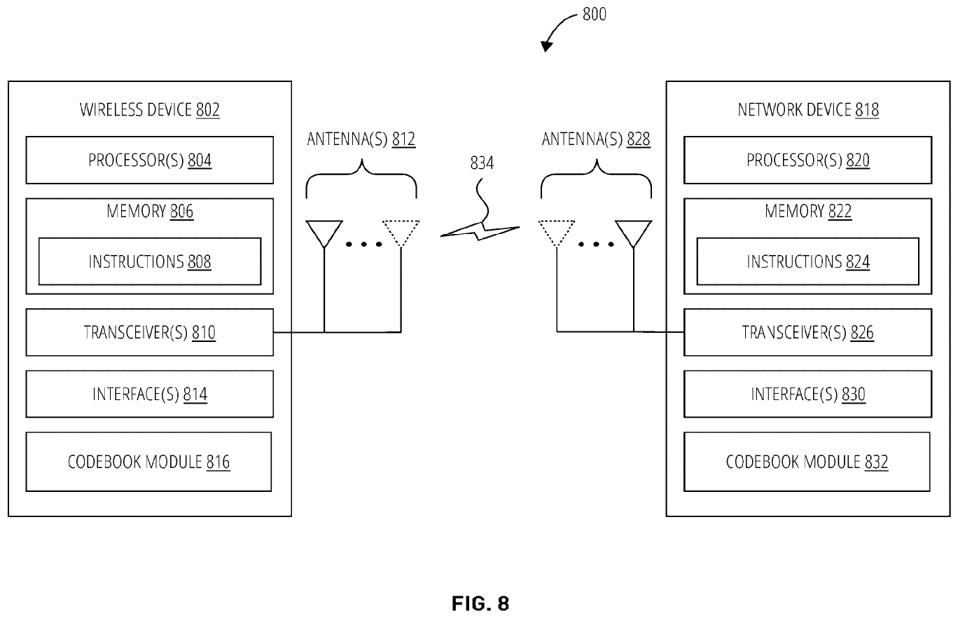

FIG. 7 illustrates an example architecture of a wireless communication system 700, according to embodiments disclosed herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations, such as base station 712 and base station 714, which enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system 700 is an NR system (e.g., when CN 724 is a 5GC), the interface 722 may be an Xn interface. The Xn interface is defined between two or more base stations (e.g., two or more gNBs and the like) that connect to 5GC, between a base station 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

FIG. 8 illustrates a system 800 for performing signaling 834 between a wireless device 802 and a network device 818, according to embodiments disclosed herein. The system 800 may be a portion of a wireless communications system as herein described. The wireless device 802 may be, for example, a UE of a wireless communication system. The network device 818 may be, for example, a base station (e.g., an eNB or a gNB) or TRP of a wireless communication system.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter and/or receiver circuitry that use the antenna(s) 812 of the wireless device 802 to facilitate signaling (e.g., the signaling 834) to and/or from the wireless device 802 with other devices (e.g., the network device 818) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include a codebook module 816. The codebook module 816 may be implemented via hardware, software, or combinations thereof. For example, the codebook module 816 may be implemented as a processor, circuit, and/or instructions 808 stored in the memory 806 and executed by the processor(s) 804. In some examples, the codebook module 816 may be integrated within the processor(s) 804 and/or the transceiver(s) 810. For example, the codebook module 816 may be implemented by a combination of software components (e.g., executed by a DSP or a general processor) and hardware components (e.g., logic gates and circuitry) within the processor(s) 804 or the transceiver(s) 810.

The codebook module 816 may be used for various aspects of the present disclosure. For example, the codebook module 816 may be configured to perform the UE-based methods disclosed herein.

The network device 818 may include one or more processor(s) 820. The processor(s) 820 may execute instructions such that various operations of the network device 818 are performed, as described herein. The processor(s) 804 may include one or more baseband processors implemented using, for example, a CPU, a DSP, an ASIC, a controller, an FPGA device, another hardware device, a firmware device, or any combination thereof configured to perform the operations described herein.

The network device 818 may include a memory 822. The memory 822 may be a non-transitory computer-readable storage medium that stores instructions 824 (which may include, for example, the instructions being executed by the processor(s) 820). The instructions 824 may also be referred to as program code or a computer program. The memory 822 may also store data used by, and results computed by, the processor(s) 820.

The network device 818 may include one or more transceiver(s) 826 that may include RF transmitter and/or receiver circuitry that use the antenna(s) 828 of the network device 818 to facilitate signaling (e.g., the signaling 834) to and/or from the network device 818 with other devices (e.g., the wireless device 802) according to corresponding RATs.

The network device 818 may include one or more antenna(s) 828 (e.g., one, two, four, or more). In embodiments having multiple antenna(s) 828, the network device 818 may perform MIMO, digital beamforming, analog beamforming, beam steering, etc., as has been described.

The network device 818 may include one or more interface(s) 830. The interface(s) 830 may be used to provide input to or output from the network device 818. For example, a network device 818 that is a base station may include interface(s) 830 made up of transmitters, receivers, and other circuitry (e.g., other than the transceiver(s) 826/antenna(s) 828 already described) that enables the base station to communicate with other equipment in a core network, and/or that enables the base station to communicate with external networks, computers, databases, and the like for purposes of operations, administration, and maintenance of the base station or other equipment operably connected thereto.

The network device 818 may include a codebook module 832. The codebook module 832 may be implemented via hardware, software, or combinations thereof. For example, the codebook module 832 may be implemented as a processor, circuit, and/or instructions 824 stored in the memory 822 and executed by the processor(s) 820. In some examples, the codebook module 832 may be integrated within the processor(s) 820 and/or the transceiver(s) 826. For example, the codebook module 832 may be implemented by a combination of software components (e.g., executed by a DSP or a general processor) and hardware components (e.g., logic gates and circuitry) within the processor(s) 820 or the transceiver(s) 826.

The codebook module 832 may be used for various aspects of the present disclosure. For example, the codebook module 832 may be configured to perform the network-based methods disclosed herein.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE) to perform dynamic point selection (DPS) in a wireless network, the method comprising:
receiving, at the UE, signals from a plurality of transmission and reception points (TRPs), wherein different non-zero power (NZP) channel state information (CSI) reference signal (RS) resources are configured for different ones of the plurality of TRPs:
selecting, at the UE, based on the signals, one or more selected TRP of the plurality of TRPs for multiple TRP (multi-TRP) coherent joint transmission (CJT) CSI feedback:
configuring a CSI-RS resource indicator (CRI) field in the multi-TRP CJT CSI feedback to indicate the one or more selected TRP; and
reporting, from the UE to the wireless network, the multi-TRP CJT CSI feedback.

2. The method of claim 1, wherein the multi-TRP CJT CSI feedback comprises uplink control information (UCI) in a first CSI part (CSI part 1) and a second CSI part (CSI part 2), and wherein the CRI is reported in the CSI part 1.

3. The method of claim 1, wherein the multi-TRP CJT CSI feedback uses a codebook W given by
$$W = [ \begin{matrix}{c}^{1} \cdot {W}^{1} \\ … \\ {c}^{T} \cdot {W}^{T}\end{matrix} ] ,$$
for linear combination coefficients, codebooks, a TRP index t, and a total number T of the plurality of TRPs,
wherein
$${W}^{t} = {W}_{1}^{t} \cdot {W}_{2}^{t} \cdot {W}_{f}^{t}$$
for a spatial basis selection matrix
$${W}_{1}^{t} ,$$
a combination coefficient matrix
$${W}_{2}^{t} ,$$
and a frequency basis selection matrix
$${W}_{f}^{t} .$$

4. The method of claim 3, further comprising:
reporting, in the multi-TRP CJT CSI feedback, the linear combination coefficients, the spatial basis selection matrix
$${W}_{1}^{t} ,$$
the combination coefficient matrix
$${W}_{2}^{t} ,$$
and the frequency basis selection matrix
$${W}_{f}^{t}$$
corresponding to the one or more selected TRP of the plurality of TRPs; and
omitting, from the multi-TRP CJT CSI feedback, the linear combination coefficients, the spatial basis selection matrix
$${W}_{1}^{t} ,$$
the combination coefficient matrix
$${W}_{2}^{t} ,$$
and the frequency basis selection matrix
$${W}_{f}^{t}$$
corresponding to the non-selected TRP of the plurality of TRPs.

5. The method of claim 3, wherein a bitwidth of the CRI field comprises
$$⌈ {log}_{2} ( {\prod }_{i = 1}^{T} ( {N}_{i} - 1 ) - 1 ) ⌉ ,$$
where Nᵢ is a number of CSI-RS resources configured as a channel measurement resource (CMR) for a TRP i, and Π is a product operation.

6. The method of claim 1, wherein the UE is configured by the wireless network to use a same CSI to report the multi-TRP CJT CSI feedback, and wherein the UE is configured by the wireless network to simultaneously report a predetermined number of best TRP CJT operation.

7. The method of claim 6, wherein the predetermined number is in a range between one and four.

8. The method of claim 1, wherein for each TRP of the plurality of TRPs, the UE is configured by the wireless network with only one of the NZP CSI-RS resources as a channel measurement resource.

9. A method for a wireless network for dynamic point selection (DPS) operation, the method comprising:
determining that a user equipment (UE) is configured to receive signals from a plurality of transmission and reception points (TRPs);
configuring different non-zero power (NZP) channel state information (CSI) reference signal (RS) resources for different ones of the plurality of TRPs:
configuring the UE to generate, based on the signals, multiple TRP (multi-TRP) coherent joint transmission (CJT) CSI feedback:
receiving, from the UE, a CSI-RS resource indicator (CRI) field in the multi-TRP CJT CSI feedback that indicates one or more selected TRP for the DPS operation; and
sending, to the UE from the one or more selected TRP, a physical downlink shared channel (PDSCH) and its demodulation reference signal (DMRS) transmission based on the multi-TRP CJT CSI feedback.

10. The method of claim 9, wherein the multi-TRP CJT CSI feedback comprises uplink control information (UCI) in a first CSI part (CSI part 1) and a second CSI part (CSI part 2), and wherein the CRI is reported in the CSI part 1.

11. The method of claim 9, wherein the multi-TRP CJT CSI feedback uses a codebook W given by
$$W = [ \begin{matrix}{c}^{1} \cdot {W}^{1} \\ … \\ {c}^{T} \cdot {W}^{T}\end{matrix} ] ,$$
for linear combination coefficients, codebooks, a TRP index t, and a total number T of the plurality of TRPs,
wherein
$${W}^{t} = {W}_{1}^{t} \cdot {W}_{2}^{t} \cdot {W}_{f}^{t}$$
a spatial basis selection matrix
$${W}_{1}^{t} ,$$
a combination coefficient matrix
$${W}_{2}^{t} ,$$
and a frequency basis selectin matrix
$${W}_{f}^{t} .$$

12. The method of claim 11, further comprising:
decoding, from the multi-TRP CJT CSI feedback, the linear combination coefficients, the spatial basis selection matrix
$${W}_{1}^{t} ,$$
the combination coefficient matrix
$${W}_{2}^{t} ,$$
and the frequency basis selection matrix:
$${W}_{f}^{T}$$
corresponding to the one or more selected TRP of the plurality of TRPs,
wherein the linear combination coefficients, the spatial basis selection matrix
$${W}_{1}^{t} ,$$
the combination coefficient matrix
$${W}_{2}^{t} ,$$
and the frequency basis selection matrix
$${W}_{f}^{T}$$
corresponding to non-selected TRP of the plurality of TRPs are omitted, from the multi-TRP CJT CSI feedback.

13. The method of claim 11, wherein a bitwidth of the CRI field comprises
$$⌈ {log}_{2} ( {\prod }_{i = 1}^{T} ( {N}_{i} - 1 ) - 1 ) ⌉ ,$$
where Nᵢ is a number of CSI-RS resources configured as a channel measurement resource (CMR) for a TRP i, and Π is a product operation.

14. The method of claim 9, further comprising configuring the UE, by the wireless network, to:
use a same CSI to report the multi-TRP CJT CSI feedback; and
simultaneously report a predetermined number of best TRP CJT operation.

15. The method of claim 14, wherein the predetermined number is in a range between one and four.

16. The method of claim 9, further comprising, for each TRP of the plurality of TRPs, configuring the UE, by the wireless network, with only one of the NZP CSI-RS resources as a channel measurement resource.

17. A method for a user equipment (UE) to perform dynamic point selection (DPS) in a wireless network, the method comprising:
receiving, at the UE, signals from a plurality of transmission and reception points (TRPs);
selecting, at the UE, based on the signals, one or more selected TRP of the plurality of TRPs for multiple TRP (multi-TRP) coherent joint transmission (CJT) channel state information (CSI) feedback;
generating, at the UE, the multi-TRP CJT CSI feedback comprising one or more linear combination coefficients to indicate the one or more selected TRP; and
reporting, from the UE to the wireless network, the multi-TRP CJT CSI feedback.

18. The method of claim 17, wherein differential encoding is used to between different ones of the plurality of TRPs to compress quantization bits for the linear combination coefficients, and
wherein the method further comprises indicating, from the UE to the wireless network in the CSI feedback, a strongest TRP of the one or more selected TRPs.

19. The method of claim 17, wherein the UE is configured by the wireless network to use a same CSI to report the multi-TRP CJT CSI feedback, and wherein the UE is configured by the wireless network to simultaneously report a predetermined number of best TRP CJT operation.

20. The method of claim 19, wherein the predetermined number is in a range between one and four.

21-29. (canceled)
